(19) United States
(12) Patent Application Publication
(10) Pub. No.: US 2017/0045812 A1
(43) Pub. Date: Feb. 16, 2017

(54) AUTOFOCUS PROJECTION SYSTEM AND FOCUS ADJUSTMENT ASSEMBLY

(71) Applicant: Young Optics Inc., Hsinchu Science Park (TW)

(72) Inventors: S-Wei CHEN, Hsinchu Science Park (TW); Wan-Chang FAN, Hsinchu Science Park (TW); Yung-Fu CHIU, Hsinchu Science Park (TW)

(21) Appl. No.: 14/826,759

(22) Filed: Aug. 14, 2015

(51) Int. Cl. G03B 21/53; G02B 7/02; G02B 13/00; G02B 7/09

(52) U.S. Cl. CPC G03B 21/53; G02B 7/09; G02B 7/022; G02B 13/001

(57) ABSTRACT

An auto-focus projection system includes a light valve, a projecting lens, a camera module, a processing circuitry, and a focusing adjustment assembly. The light valve converts an illumination beam into an image beam, and the projection lens projects the image beam. The projection lens forms different images with respective sharpness values at different focusing positions The camera module captures the different images and converting the different images into electrical signals. The processing circuitry receives the electrical signals and compares the sharpness values to generate a control signal. The focus adjustment assembly receives the control signal and moves the projection lens according to the control signal.

### BACKGROUND OF THE INVENTION

Field of the Invention

The invention relates generally to a projection system, and more particularly to an autofocus projection lens system.

Description of the Related Art

Automatic focus is a feature of some optical systems that allows them to continuously maintain correct focus on a subject. Focusing is the moving of the lens in and out until the sharpest possible image of the subject is projected onto an object. Autofocus systems rely on one or more sensors to determine correct focus and a mechanism to move the lens to an in-focus position. Active autofocus systems measure distance to the subject independently of the optical system, and subsequently adjust the optical system for correct focus. Passive autofocus systems determine correct focus by performing passive analysis of the image that is entering the optical system. These systems (e.g., sharpness detection) generally do not direct any energy, such as ultrasonic sound or infrared light waves, toward the subject. It has generally been considered to provide autofocus capabilities in a projector. Consistent with an auto-focus capability, the projector projects an image onto a projection screen, captures an image of the projected image, and moves the projection lens iteratively from an out-of-focus position toward an in-focus position. However, since the product demand for a thinned projector is increasing, it is desirable to optimize the arrangement and construction of a mechanism to move the lens in an autofocus projector to, for example, reduce size and improve focus adjustment accuracy.

### BRIEF SUMMARY OF THE INVENTION

According to one aspect of the present disclosure, a focus adjustment assembly includes at least one guide pin, a threaded shaft and a thread engagement member. The guide pin has a longitudinal axis, and a projection lens is slidably coupled to the guide pin to slide in a forward direction or a reverse direction substantially parallel to the longitudinal axis of the guide pin to project different images with respective sharpness values. The threaded shaft has at least one thread, the threaded shaft advances or withdraws at increments in response to the sharpness values, and the threaded shaft has a longitudinal axis substantially parallel to the longitudinal axis of the guide pin. The thread engagement member is connected to the projection lens and configured to engage the thread of the threaded shaft. The thread engagement member is provided with a first contact point and a second contact point in slidably contact with the thread, and the thread pushes against the first contact point to move the projection lens in the forward direction or pushes against the second contact point to move the projection lens in the reverse direction to allow the projection lens to reach an in-focus position.

According to the above embodiment, since a projection lens may slide along a guide pin simultaneous with an axial movement of a driven shaft simply by bridging a clap member between the projection lens and the driven shaft, the mechanism for realizing automatic focusing can be simplified, and a high response speed for focus adjustment is obtained. Besides, the position of the projection lens can be finely tuned based on small increments of the movement of the shaft. For example, such mechanism is suitable for microstep calibration in cooperation with a driving device to further improve focus adjustment accuracy. Further, the shaft may move about its longitudinal axis parallel to the longitudinal axis of the guide pin as well as the sliding direction of the projection lens to further simplify the linkage arrangement, reduce occupied space, and avoid possible interference of neighboring components.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one.

FIG. 1 is a schematic diagram illustrating an autofocus projection system according to an embodiment of the invention.

FIG. 2 illustrating the contrast between a high sharpness image and a low sharpness

FIG. 3A shows a flow chart illustrating auto focusing operations according to an embodiment of the invention.

FIG. 3B shows a flow chart illustrating auto focusing operations according to another embodiment of the invention.

FIG. 4 is a perspective view of one embodiment of an implementation of a focus adjustment assembly for an autofocus projection system.

FIG. 5A is a schematic view illustrating positional relationship of a mechanical element relative to a shaft according to an embodiment of the invention.

FIG. 5B is a schematic view illustrating positional relationship of a mechanical element relative to a shaft according to another embodiment of the invention.

FIG. 6 is a schematic diagram illustrating a projection lens according to an embodiment of the invention.

FIG. 7 is an exploded view of one embodiment of another implementation of a focus adjustment assembly.

FIG. 8 is a perspective view showing an assembled focus adjustment assembly of FIG. 7.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

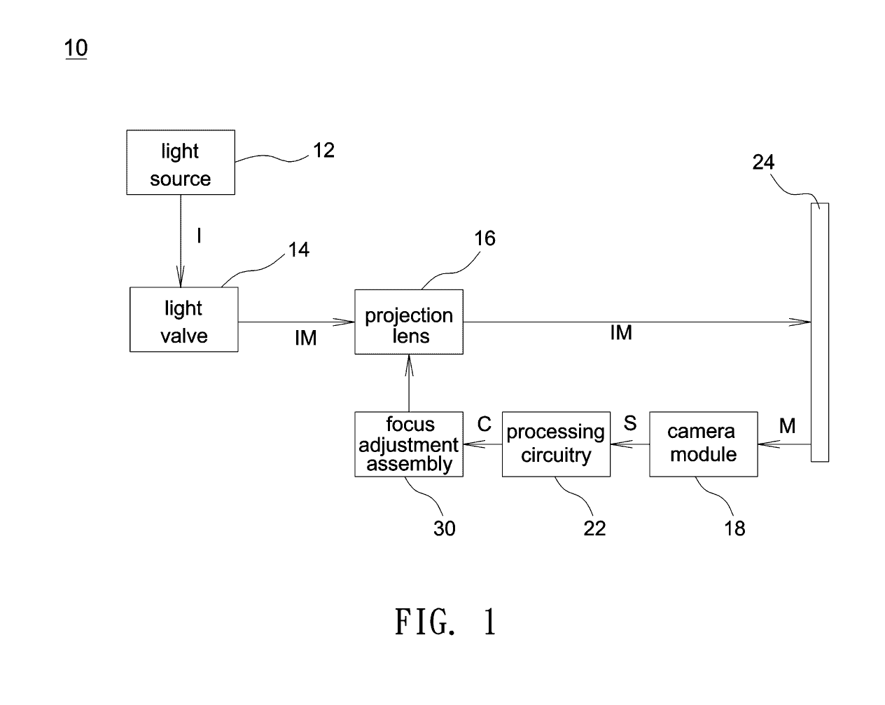

FIG. 1 is a schematic diagram illustrating an autofocus projection system according to an embodiment of the invention. As illustrated in FIG. 1, an autofocus projection system 10 may include a light source 12, a light valve 14, a projecting lens 16, a camera module 18, a processing circuitry 22, and a focus adjustment assembly 30.

The light valve 14 converts an illumination beam I emitted by the light source 12 into an image beam IM. In one embodiment, the light valve 14 may be a DMD or an LCOS to modify the illumination beam I to form the image beam 1M. The projecting lens 16 projects the image beam IM on an object such as a screen 24 to form an image M. The camera module 18 captures different images M projected by the projecting lens 16 at different positions and converts the captured images M into electrical signals S. In one embodiment, the camera module 18 may include at least one pick-up lens and an image sensor, and the image sensor may be a charge-coupled device (CCD) or a complementary metal-oxide-semiconductor (CMOS). The pick-up lens may be disposed separate from the projecting lens 16 or integrated into the projecting lens 16 as one piece.

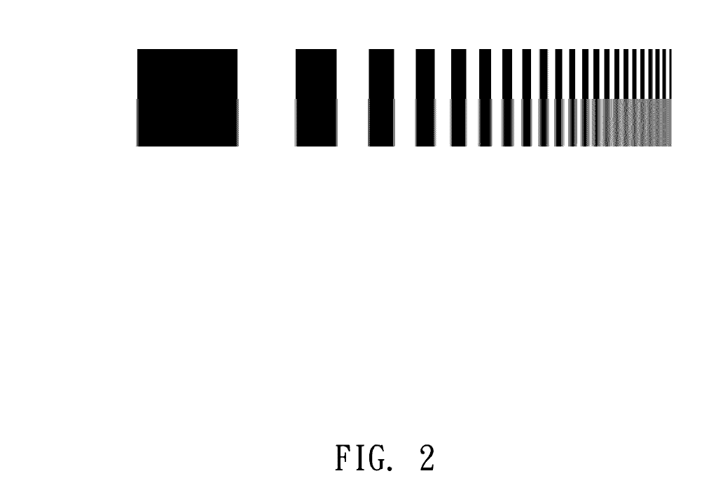

The processing circuitry 22 receives the electrical signals S from the camera module 18 and evaluates the image sharpness of each fetched image. In one embodiment, a maximum sharpness value between corresponding points in successive images may be assumed to correspond to “best” focus. As illustrated in FIG. 2, the image sharpness may be measured by multiple line pairs having gradually-increased density. An image with high sharpness (top half of FIG. 2) shows line pairs that can be clearly distinct from each other. In contrast, line pairs shown in an image with low sharpness (bottom half of FIG. 2) are blurred and their boundaries are unclear. Note the sharpness value corresponding to a fetched image and evaluated by the processing circuitry 22 may be a static value or a dynamic value based on image statistics. For example, the camera module 18 may capture the same image M projected on the screen 24 several times and determine the sharpness value of the image M according to the statistics on the values fetched by the several times. Besides, the sharpness value can be evaluated by different methods known in the art. For example, the sharpness value may be determined as the edge contrast of an image or a combination of both resolution and acutance. That is, the evaluation of sharpness value is not limited to a specific method and may depend on environment factors and actual demands. The processing circuitry 22 may compare different sharpness values obtained from the images M corresponding to different positions of the projecting lens 16, and then transmits a control signal C according to the comparison results to the focus adjustment assembly 30. The focus adjustment assembly 30 is activated by the control signal C to adjust the projection lens 16 to an in-focus position (for example, a focusing position achieving highest image sharpness).

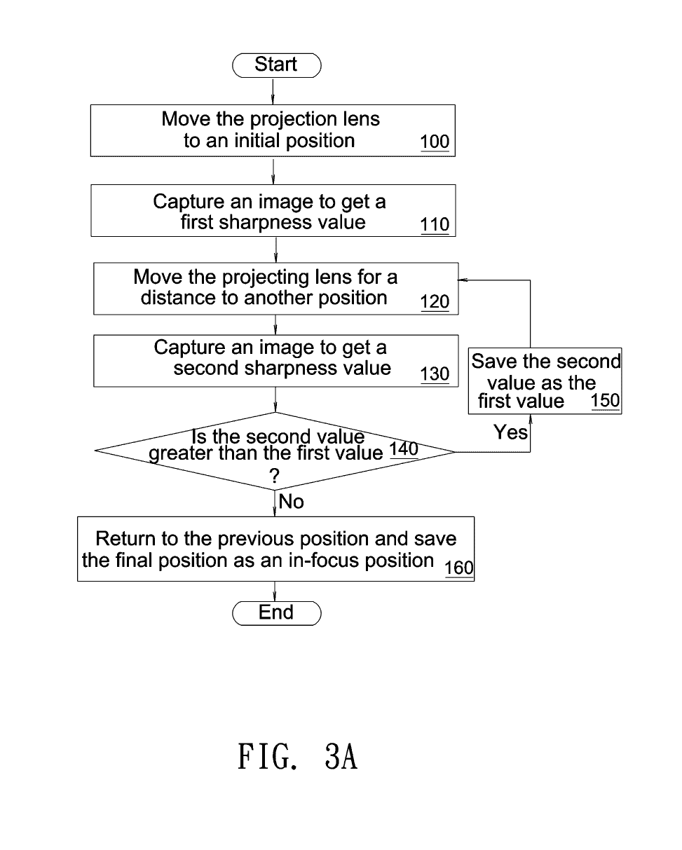

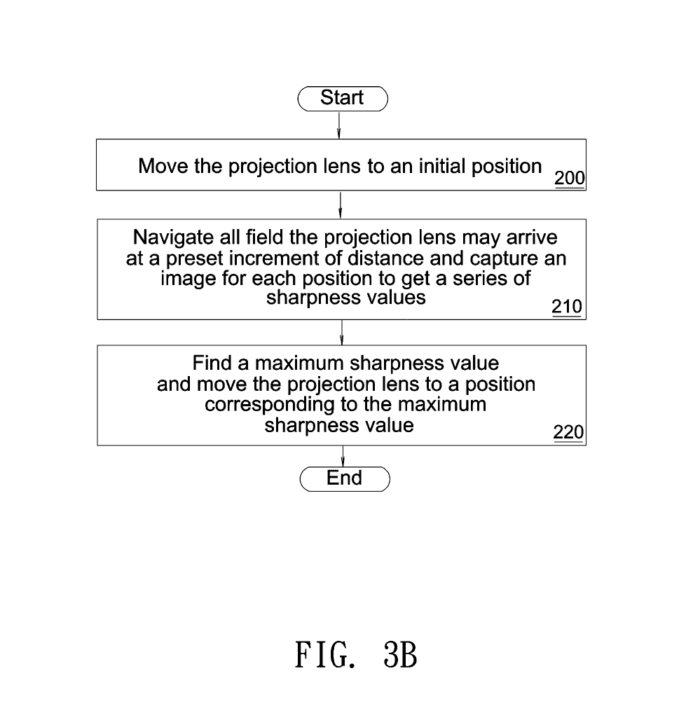

The processing circuitry 22 may execute instructions necessary to carry out or control the operation of many functions performed by the autofocus projection system 10. In one exemplary embodiment shown in FIG. 3A, the projecting lens 16 first moves to an initial position (Step 100), the camera module 18 captures an image on the screen 24 and transmits it to the processing circuitry 22 to get a first sharpness value (Step 110), and the processing circuitry 22 controls the focus adjustment assembly 30 to move the projecting lens 16 in a forward direction for a predetermined distance (Step 120). Then, the camera module 18 activates again to capture an updated image on the screen 24 to get a second sharpness value (Step 130), and the processing circuitry 22 compares the second sharpness value with the first sharpness value (Step 140). The processing circuitry 22 controls the focus adjustment assembly 30 to move the projecting lens 16 in the forward direction for another predetermined distance when the second sharpness value is greater than the first sharpness value, and save the second sharpness value as the first sharpness value (Step 150). On the contrary, the processing circuitry 22 controls the focus adjustment assembly 30 to move the projecting lens 16 in a reverse direction for a predetermined distance when the second sharpness value is not greater than the first sharpness value. The above automatic focusing steps are repeated until the processing circuitry 22 finds that the latest sharpness value is less than or equal to the preceding sharpness value, which means the image now on the screen 24 is clearest (Step 160). Therefore, the projecting lens 16 may stay in the in-focus position, and the automatic focusing procedure stops. In an alternate embodiment shown in FIG. 3B, the projecting lens 16 first moves to an initial position (Step 200), and then the projecting lens 16 may navigate all field it may arrive and move at a preset increment of distance, and the camera module 18 captures an image for each position of the projecting lens 12 and transmits the images to the processing circuitry 22 to get a series of sharpness values (Step 210). The above steps are repeated until the projecting lens 12 has navigated all field it may arrive. Finally, the processing circuitry 22 may find a maximum value of the series of sharpness values, and the projecting lens 16 is moved to the position corresponding to the maximum sharpness value (Step 220). Note the camera module 18 may provide the processing circuitry 22 with information except for the sharpness values. For example, the processing circuitry 22 may receive the information of an image currently projected on the screen 24, such as frame shape, brightness, hue, etc., and correspondingly adjust them to optimize the image quality.

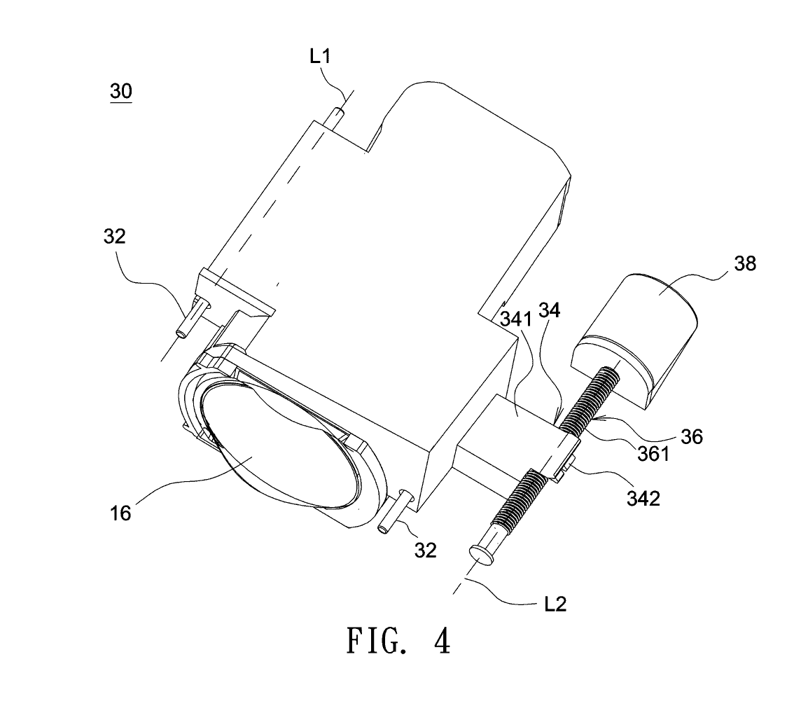

As shown in FIG. 4, the focus adjustment assembly 30 may include at least one guide pin 32, a mechanical element 34, a shaft 36, and a driving device 38. The guide pin 32 has a longitudinal axis L1, and the projection lens 16 is slidably coupled to the guide pin 32 to slide in a forward direction or a reverse direction that are substantially parallel to the longitudinal axis L1 and to stay at different positions. Therefore, the projection lens 16 sliding along the guide pin 32 may project images with different sharpness values at different positions. The shaft 36 has a longitudinal axis L2, and the shaft 36 may be driven to cause movement, and the movement may be made with respect to the longitudinal axis L2. For example, the shaft 36 may rotate about the longitudinal axis L2, move along the longitudinal axis L2, or both. In this embodiment, the longitudinal axis L2 of the shaft 36 may be substantially parallel to the longitudinal axis L1 of the guide pin 32. Certainly, the longitudinal axis L2 of the shaft 36 may be not parallel to the longitudinal axis L1 of the guide pin 32 in an alternate embodiment. In one embodiment, the shaft 36 may be driven by the driving device 38 in response to a control signal C from the processing circuitry 22 to cause movement. The driving device 38 may be, for example, a motor, a piezoelectric actuator or a voice coil. Note the motor serving as the driving device 38 is not limited to a specific type. For example, a stepping motor with microstep calibration may be used to drive the shaft 36. The mechanical element 34 bridges between the projection lens 16 and the shaft 36, where one end 341 of the mechanical element 34 is connected to the projection lens 16 and an opposite end 342 of the mechanical element 34 is in slidably contact with the shaft 36. The end 341 may be, for example, pivotally connected to the projection lens 16. Therefore, when the shaft 36 is driven by, for example, the driving device 38, the shaft 36 may cause movement to allow the projection lens 16 to slide along the guide pin 32 in a first direction or a second direction opposite the first direction to change its positions. The first direction may be a forward direction, and the second direction may be a reverse direction. In one embodiment, the projection lens 16 is continually moved until reaching an in-focus position where the captured image has a maximum image sharpness.

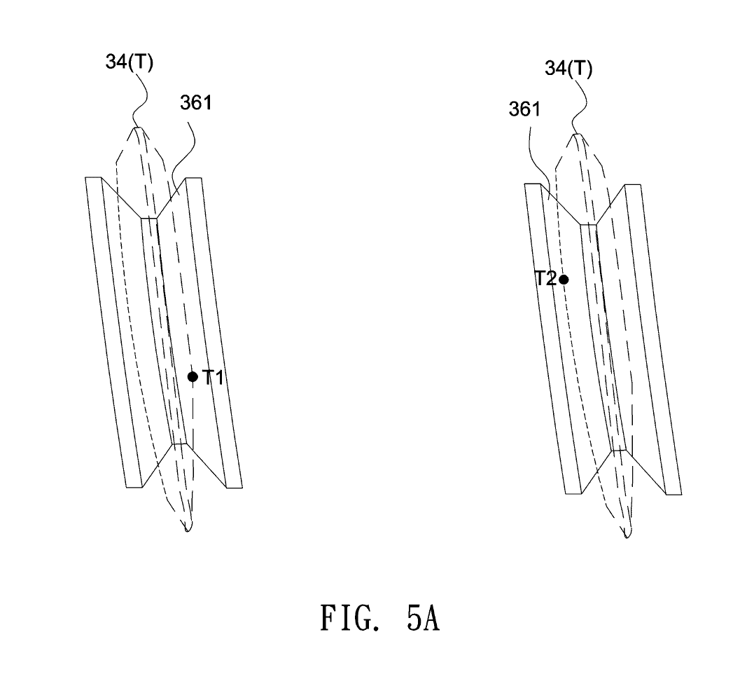

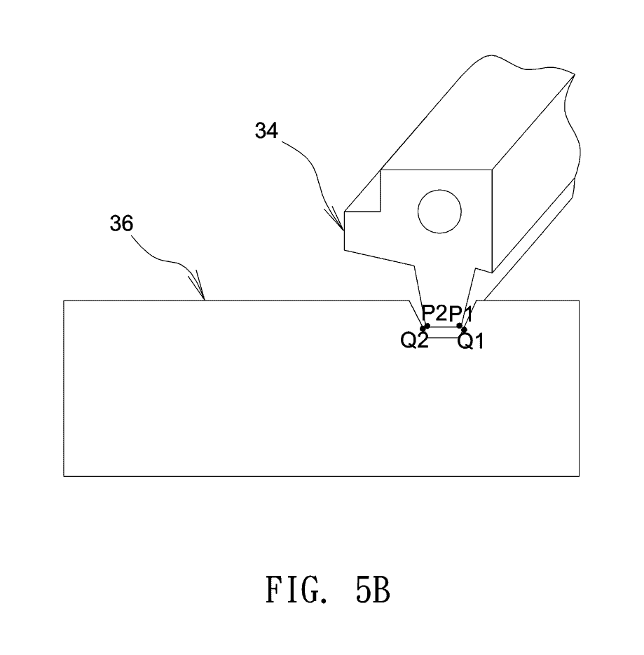

As illustrated in FIG. 4, in one embodiment, the shaft 36 may be a threaded shaft having at least one thread 361, and the mechanical element 34 may be a thread engagement member configured to engage the thread 361 of the shaft 36. The shaft 36 may advance or withdraw at increments in response to a control signal C from the processing circuitry 22 that compares different sharpness values fetched at different positions of the projection lens 16. As shown in FIG. 5A, an internal thread T (shown in dashed lines) may be formed on one end of the mechanical element 34 and mates with the thread 361 of the shaft 36. Therefore, the mechanical element 34 is provided with different thread contact points (such as thread contact points T1 and T2) in slidably contact with the thread 361 of the shaft 36. When the shaft 36 is driven by, for example, the driving device 38, the thread 361 of the shaft 36 may push against the thread contact point T1 to move the projection lens 16 in a first direction (left side of FIG. 5A) or push against the thread contact point T2 to move the projection lens 16 in a second direction opposite the first direction (right side in FIG. 5A). Further, as shown in FIG. 5B, simply by providing the shaft 36 with a first contact point Q1 and a second contact point Q2 separate from the first contact point Q1 and providing the mechanical element 34 with a third contact point P1 and a fourth contact point P2 separate from the third contact point P1, the first contact point Q1 may push against the third contact point P1 to move the projection lens 16 in a first direction, and the second contact point Q2 may push against the fourth contact point P2 to move the projection lens 16 in a second direction opposite the first direction to allow the projection lens 16 to reach an in-focus position based on a comparison of the sharpness values, when the shaft 36 is driven to cause movement. Therefore, the mechanical element 34 is not limited to a specific structure. For example, the mechanical element 34 and the shaft 36 may both include a gear part, and the contact points P1 and P2 are formed in the gear part of the mechanical element 34 and pushed by the gear part of the shaft 36. In an alternate embodiment, the contact points P1 and P2 are formed in the thread part (such as the internal thread T) of the shaft 36 and pushed by the gear part of the shaft 36. Hence, the shape of the mechanical element 34 and the shaft 36 are not restricted and may include at least a part of a grapple, claw, chipper, hook, pawl, grab, gear, screw or any other machinery piece known in the art

According to the above embodiments, since a projection lens may slide along a guide pin simultaneous with the movement of a driven shaft simply by bridging a mechanical element between the projection lens and the driven shaft, the mechanism for realizing automatic focusing can be simplified, and a high response speed for focus adjustment is obtained. Besides, the position of the projection lens can be finely tuned based on small increments of the movement of the shaft. For example, such mechanism is suitable for microstep calibration in cooperation with a driving device to further improve focus adjustment accuracy. Besides, the shaft may move about its longitudinal axis parallel to the longitudinal axis of the guide pin as well as the sliding direction of the projection lens to further simplify the linkage arrangement, reduce occupied space, and avoid possible interference of neighboring components.

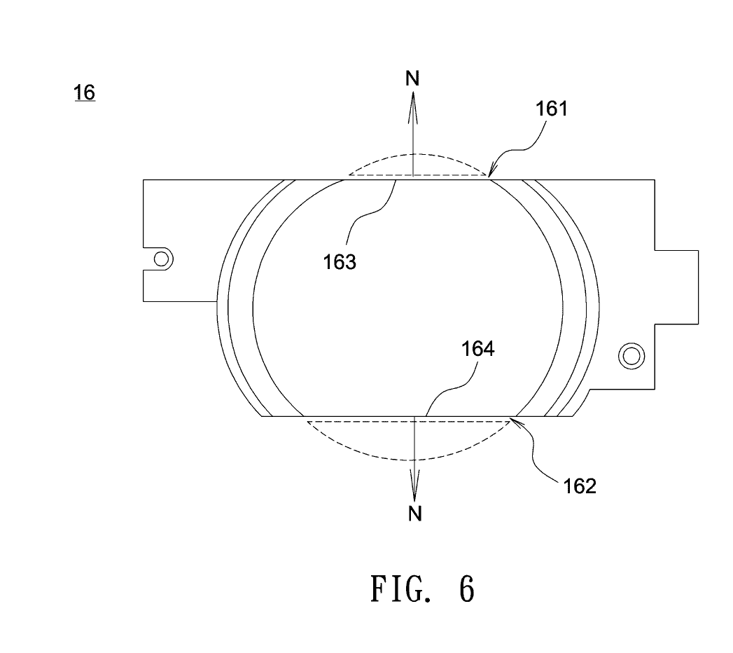

Further, in one embedment, the projection lens 16 may have at least one side cut to fit a thinner projector. For example, as shown in FIG. 6, the projection lens 16 has two side cuts 161 and 162 (a top circular segment portion and a bottom segment portion indicated by dashed lines are removed), and the side cuts 161 and 162 may shape the projection lens 16 to form a top flat surface 163 and a bottom flat surface 164. In one embodiment, the top flat surface 163 may be substantially parallel to the bottom flat surface 164, and a normal N of the top flat surface 163 or the bottom flat surface 164 may be substantially perpendicular to the longitudinal axis L1 of the guide pin 32. Such arrangement may facilitate smooth movement of the projection lens 16 along the guide pin 32 and in a thinner projector.

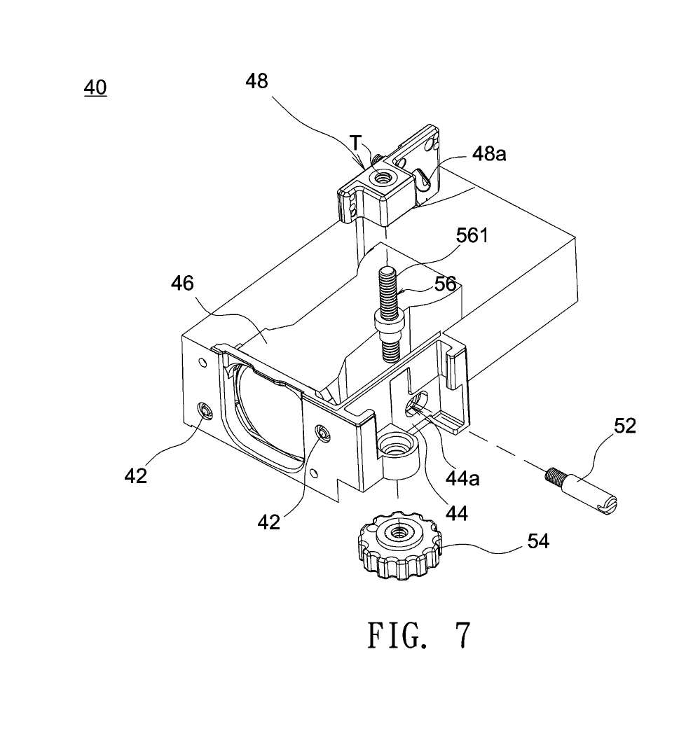

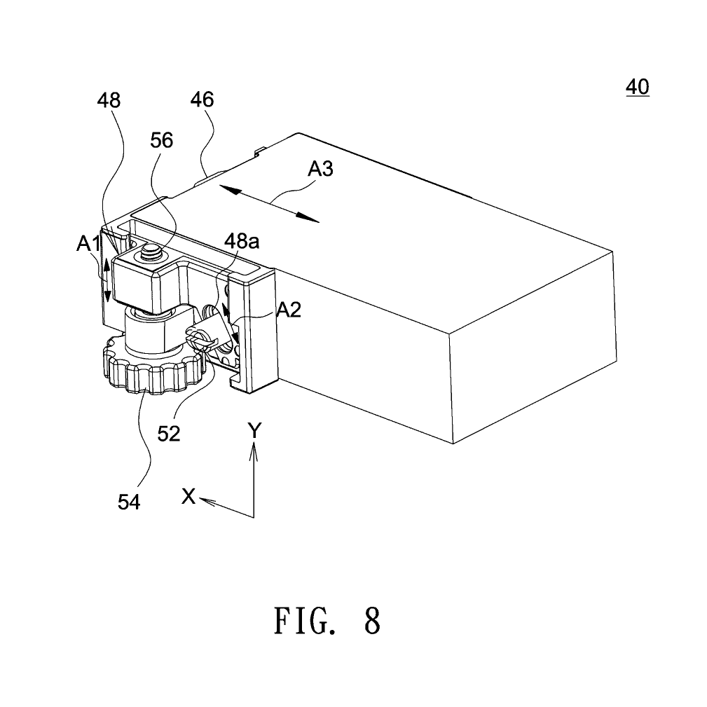

FIG. 7 is an exploded view of one embodiment of another implementation of a focus adjustment assembly. FIG. 8 is a perspective view showing an assembled focus adjustment assembly of FIG. 7. As shown in FIG. 7, in a focus adjustment assembly 40, a projection lens 46 may be received in a chassis 44 and is slidably coupled to at least one guide pin 42. The chassis 44 is provided with a through hole 44a. A thread engagement member 48 may have an internal thread T and an oblique guide slot 48a. The internal thread T of the thread engagement member 48 may mate with a thread 561 of a threaded shaft 56, and a thumb wheel 54 may be provided on one end of the threaded shaft 56. A guide bar 52 may be fixed on the projection lens 46, and the guide bar 52 may stick out through the through hole 44a on the chassis 44 and may be inserted into the oblique guide slot 48a. Therefore, the guide bar 52 may be drivably coupled with the thread engagement member 48. As shown in FIG. 8, when the threaded shaft 56 is turned clockwise or counterclockwise by manually turning the thumb wheel 54 or by the drive of a driving device such as a motor (not shown), the thread engagement member 48 may be pushed by the threaded shaft 56 to move upwards or downwards (indicated by arrow A1) to thus force the guide bar 52 to move along the oblique guide slot 48a in a direction indicated by arrow A2. Therefore, the guide bar 52 moving along the oblique guide slot 48a may provide both the X-axis displacement and the Y-axis displacement, and, for the guide bar 52 being fixed on the projection lens 46, the X-axis displacement of the guide bar 52 enables the projection lens 46 to slide along the guide pin 42 in a direction indicated by arrow A3 to reach an in-focus position. Further, in an alternate embodiment, the thread engagement member 48, the threaded shaft 56 and the thumb wheel 54 may be omitted from the focus adjustment assembly 40, and a user may manually move the guide bar 52 to adjust the position of the projection lens 46 and allow the projection lens 46 to reach an in-focus position.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understand as requiring that such operations be performed in the particular order shown or in sequential order, or that all illustrated operations be performed, to achieve desirable results. Moreover, the separation of various system components in the embodiments described above should not be understood as requiring such separation in all embodiments. Various modifications may be made to the disclosed implementations and still be within the scope of the following claims.

What is claimed is:

1. A focus adjustment assembly, comprising:
at least one guide pin having a longitudinal axis, wherein a projection lens is slidably coupled to the guide pin to slide in a forward direction or a reverse direction substantially parallel to the longitudinal axis of the guide pin;
a threaded shaft having at least one thread, the threaded shaft advancing or withdrawing at increments in response to a control signal, and the threaded shaft having a longitudinal axis substantially parallel to the longitudinal axis of the guide pin; and
a thread engagement member connected to the projection lens and configured to engage the thread of the threaded shaft, wherein the thread engagement member is provided with a first thread contact point and a second thread contact point in slidably contact with the thread, and the thread of the threaded shaft pushes against the first thread contact point to move the projection lens in the forward direction or pushes against the second thread contact point to move the projection lens in the reverse direction to allow the projection lens to reach an in-focus position.

2. The focus adjustment assembly as claimed in claim 1, further comprising:
a driving device for driving the threaded shaft.

3. The focus adjustment assembly as claimed in claim 1, wherein the projection lens has at least one side cut.

4. The focus adjustment assembly as claimed in claim 3, wherein the side cut shape the projection lens to form a flat surface, and a normal of the flat surface is substantially perpendicular to the longitudinal axis of the guide pin.

5. The focus adjustment assembly as claimed in claim 3, wherein the projection lens has two side cuts provided on opposite sides of the projection lens, and the two side cuts shape the projection lens to form a top flat surface and a bottom flat surface substantially parallel to the top flat surface.

6. The focus adjustment assembly as claimed in claim 1, wherein the thread engagement member has an internal thread mating with the thread of the threaded shaft.

7. A focus adjustment assembly, comprising:
at least one guide pin having a longitudinal axis, wherein a projection lens is slidably coupled to the guide pin to slide in a first direction or a second direction opposite the first direction;
a shaft having a longitudinal axis and being driven to cause movement in response to a control signal, the shaft being provided with at least a first contact point and a second contact point separate from the first contact point; and
a mechanical element bridging between the projection lens and the shaft, wherein a first end of the mechanical element is connected to the projection lens, a second end of the mechanical element is in slidably contact with the shaft, the second end of the mechanical element is provided with at least a third contact point and a fourth contact point separate from the third contact point, the first contact point pushes against the third contact point to move the projection lens in the first direction, and the second contact point pushes against the fourth contact point to move the projection lens in the second direction to allow the projection lens to reach an in-focus position.

8. The focus adjustment assembly as claimed in claim 7, wherein the first direction and the second direction are substantially parallel to the longitudinal axis of the guide pin.

9. The focus adjustment assembly as claimed in claim 7, wherein the longitudinal axis of the shaft is substantially parallel to the longitudinal axis of the guide pin.

10. The focus adjustment assembly as claimed in claim 7, wherein the mechanical element comprises a gear part, and the third contact point and the fourth contact point are formed in the gear part.

11. The focus adjustment assembly as claimed in claim 7, wherein the mechanical element comprises a thread part, and the third contact point and the fourth contact point are formed in the thread part.

12. The focus adjustment assembly as claimed in claim 7, wherein the shaft is driven to cause the movement with respect to the longitudinal axis thereof.

13. The focus adjustment assembly as claimed in claim 7, wherein the projection lens has at least one side cut.

14. The focus adjustment assembly as claimed in claim 13, wherein the side cut shape the projection lens to form a flat surface, and a normal of the flat surface is substantially perpendicular to the longitudinal axis of the guide pin.

15. The focus adjustment assembly as claimed in claim 13, wherein the projection lens has two side cuts provided on opposite sides of the projection lens, and the two side cuts shape the projection lens to form a top flat surface and a bottom flat surface substantially parallel to the top flat surface.

16. An auto-focus projection system, comprising:
a light valve for converting an illumination beam into an image beam;
a projection lens for projecting the image beam, wherein the projection lens forms different images with respective sharpness values at different positions;
a camera module for capturing the different images and converting the different images into electrical signals;
a processing circuitry for receiving the electrical signals and comparing the sharpness values to generate a control signal; and
a focus adjustment assembly for receiving the control signal and moving the projection lens according to the control signal, the focus adjustment assembly comprising:
at least one guide pin having a longitudinal axis and slidably coupled to the projection lens, wherein the projection lens slides in a first direction or a second direction opposite the first direction;
a shaft having a longitudinal axis and being driven to cause movement in response to the control signal, the shaft being provided with at least a first contact point and a second contact point separate from the first contact point; and
a mechanical element bridging between the projection lens and the shaft, wherein a first end of the mechanical element is connected to the projection lens, a second end of the mechanical element is in slidably contact with the shaft, the second end of the mechanical element is provided with at least a third contact point and a fourth contact point separate from the third contact point, the first contact point pushes against the third contact point to move the projection lens in the first direction, and the second contact point pushes against the fourth contact point to move the projection lens in the second direction to allow the projection lens to reach an in-focus position.

17. The auto-focus projection system as claimed in claim 16, wherein the camera module comprises an image sensor, and the image sensor is a charge-coupled device (CCD) or a complementary metal-oxide-semiconductor (CMOS).

18. The auto-focus projection system as claimed in claim 16, wherein the focus adjustment assembly further comprises a driving device with microstep calibration for driving the shaft in microsteps.

19. The auto-focus projection system as claimed in claim 18, wherein the driving device is a motor, a piezoelectric actuator or a voice coil.

20. The auto-focus projection system as claimed in claim 16, wherein the projection lens has at least one side cut.
